(19) United States
(12) Patent Application Publication
(10) Pub. No.: US 2009/0208174 A1
(43) Pub. Date: Aug. 20, 2009

(54) Apparatus for positioning optical fibers

(76) Inventors: Rainer Matthias Kossat, Aschau (DE); Christian Heidler, München (DE); Bert Zamzow, Gauting-Buchendorf (DE)

Correspondence Address: Corning Cable Systems;c/o Coring Intellectual Property Department, SP TI 3 1, Corning, NY, 14831, US

(21) Appl. No.: 11/990,670

(22) PCT Filed: Aug. 17, 2006
(86) PCT No.: PCT/DE2006/001443

§ 371 Date: Apr. 1, 2009

(30) Foreign Application Priority Data
Aug. 17, 2005 (DE) 102005038937.6

(51) Int. Cl. G02B 6/255; G02B 6/00

(52) U.S. Cl. 385/97; 385/137

(57) ABSTRACT

An apparatus for splicing optical fibers is arranged on a supporting plate in the form of a printed circuit board. The apparatus comprises a first optical fiber guide, which is arranged on a spring plate to displace a first optical fiber in the longitudinal direction, and a second optical fiber guide, which is arranged on a further spring plate to displace a second optical fiber in the longitudinal direction. The spring plates are arranged on a respectively bendable lever arm. The optical fibers which have been inserted in the optical fiber guides can be displaced in a lateral direction by bending the lever arms. The precision required for alignment of the optical fibers can be provided by stepping down the forces acting on the bending apparatuses.

### FIELD OF THE INVENTION

The invention relates to an apparatus for positioning optical fibers, by means of which, for example, optical fibers can be aligned with respect to one another before a splicing process.

### BACKGROUND OF THE INVENTION

At least two optical fibers are connected by means of a splicing apparatus, in which the ends of the two optical fibers are heated, and are fused to one another. The heating process is generally carried out by means of a corona discharge between two electrode points. The splicing attenuation at the junction point between the two optical fibers is dependent inter alia on precise alignment of the two optical fibers with respect to one another, before the actual heating process. In order to align the ends of the two optical fibers, they are inserted in two mutually opposite optical fiber guides. This results in the two optical fibers to be spliced being aligned roughly with respect to one another.

Fine alignment of the two fibers is carried out, for example, by piezo-components which are arranged under the two optical fiber guides. By application of a voltage to the piezoelectric components, the optical fiber guides, which are connected to them, can be displaced with respect to one another. In this case, temperature fluctuations can also cause the two optical fiber guides to be displaced with respect to one another. Since only a slight displacement of the optical fibers can be achieved by means of the piezo-components, the position changes of the optical fiber guides caused by temperature fluctuations must be compensated for.

If the piezo-component is intended to compensate for optical fiber guide displacements caused by temperature fluctuations, a piezo-component must be used for this purpose which allows large movement changes to be achieved. Piezo-components such as these are, however, very expensive. Further high costs are also incurred by drive circuits for supplying the piezo-components with a high voltage, and by means of complex DC/DC converters.

### SUMMARY OF THE INVENTION

The object of the present invention is to provide an apparatus for positioning optical fibers, in which the optical fibers can be aligned with respect to one another in a simple and reliable manner.

The object is achieved by an apparatus for positioning optical fibers comprising a supporting plate, comprising a first optical fiber guide, into which at least a first optical fiber can be inserted, comprising a second optical fiber guide into which at least a second optical fiber can be inserted, and comprising a first movement stepping-down apparatus to displace the first optical fiber in a lateral direction transversely with respect to a longitudinal direction of the first optical fiber, which first movement stepping-down apparatus has a first end and a second end. The first optical fiber guide is arranged on an area of the first movement stepping-down apparatus which is closely adjacent to the first end of the first movement stepping-down apparatus. The apparatus furthermore comprises a first drive device which is coupled to the supporting plate and which can cause a change in the position at the second end of the first movement stepping-down apparatus. The first movement stepping-down apparatus is configured to convert the movement change caused by the first drive device at the second end of the first movement stepping-down apparatus to a smaller movement change on the area of the first movement stepping-down apparatus which is closely adjacent to the first end of the first movement stepping-down apparatus.

In an embodiment of the apparatus, a second movement stepping-down apparatus is provided to displace the second optical fiber in a lateral direction transversely with respect to a longitudinal direction of the second optical fiber, which second movement stepping-down apparatus has a first end and a second end. The second optical fiber guide is arranged on an area of the second movement stepping-down apparatus which is closely adjacent to the first end of the second movement stepping-down apparatus. Furthermore, the apparatus has a second drive device, which is coupled to the supporting plate and which can cause a change in the position at the second end of the second movement stepping-down apparatus. The second movement stepping-down apparatus is configured to convert the movement change caused by the second drive device at the second end of the second movement stepping-down apparatus to a smaller movement change on the area of the second movement stepping-down apparatus which is closely adjacent to the first end of the second movement stepping-down apparatus.

Another embodiment of the apparatus comprises a first displacement apparatus to displace the first optical fiber in the longitudinal direction of the first optical fiber, on which first displacement apparatus the first optical fiber guide is arranged, and a third drive device, which is coupled to the supporting plate and causes displacement of the first optical fiber in the longitudinal direction of the first optical fiber by means of a force acting on the first displacement apparatus. The first displacement apparatus is configured such that it produces a restoring force opposing the force caused by the third drive device. The first displacement apparatus is coupled to that area of the first movement stepping-down apparatus which is closely adjacent to the first end of the first movement stepping-down apparatus.

According to another embodiment, the apparatus has a second displacement apparatus to displace the second optical fiber in the longitudinal direction of the second optical fiber, on which second displacement apparatus the second optical fiber guide is arranged. Furthermore, a fourth drive device is provided, which is coupled to the supporting plate and causes displacement of the second optical fiber in the longitudinal direction of the second optical fiber by means of a force acting on the second displacement apparatus. The second displacement apparatus is configured such that it produces a restoring force opposing the force caused by the fourth drive device. The second displacement apparatus is coupled to that area of the second movement stepping-down apparatus which is closely adjacent to the first end of the second movement stepping-down apparatus.

Another embodiment of the apparatus provides a first supporting apparatus on which the first optical fiber guide is arranged. The first supporting apparatus is coupled to the first displacement apparatus. Furthermore, a second supporting apparatus is provided, on which the second optical fiber guide is arranged. The second supporting apparatus is coupled to the second displacement apparatus.

In an embodiment of the apparatus, the first movement stepping-down apparatus has a lever arm with a first end and a second end. The first end of the lever arm of the first movement stepping-down apparatus is connected to the supporting plate. The second end of the lever arm of the first movement stepping-down apparatus can be moved by the first drive device. The second movement stepping-down apparatus has a lever arm with a first end and a second end. The first end of the lever arm of the second movement stepping-down apparatus is connected to the supporting plate. The second end of the lever arm of the second movement stepping-down apparatus can be moved by the second drive device.

A further embodiment of the apparatus has a further first movement stepping-down apparatus to displace the first optical fiber in the lateral direction for the first optical fiber, which further first movement stepping-down apparatus has a first end and a second end. The further first movement stepping-down apparatus is configured to convert a movement change caused at the second end of the further first movement stepping-down apparatus to a smaller movement change on the area of the further first movement stepping-down apparatus which is closely adjacent to the first end of the further first movement stepping-down apparatus. The apparatus also has a further first displacement apparatus to displace the first optical fiber in the longitudinal direction of the first optical fiber as a consequence of a force caused by the third drive device. The further first displacement apparatus is configured such that it produces a restoring force opposing the force caused by the third drive device. The further first displacement apparatus is coupled to that area of the further first movement stepping-down apparatus which is closely adjacent to the first end of the further first movement stepping-down apparatus. The first supporting apparatus is arranged on the further first displacement apparatus.

Furthermore, in the case of the apparatus according to the invention, a further second movement stepping-down apparatus can be provided for displacing the second optical fiber in the lateral direction for the second optical fiber, which further second movement stepping-down apparatus has a first end and a second end. The further second movement stepping-down apparatus is configured to convert a movement change caused at the second end of the further second movement stepping-down apparatus to a smaller movement change on the area of the further second movement stepping-down apparatus which is closely adjacent to the first end of the further second movement stepping-down apparatus. Furthermore, a further second displacement apparatus is provided for displacing the second optical fiber in the longitudinal direction of the second optical fiber as a consequence of a force caused by the fourth drive device. The further second displacement apparatus is configured such that it produces a restoring force opposing the force caused by the fourth drive device. The further second displacement apparatus is coupled to that area of the further second movement stepping-down apparatus which is closely adjacent to the first end of the further second movement stepping-down apparatus. The supporting apparatus on which the second optical fiber guide is arranged on the further second displacement apparatus.

In a further embodiment of the apparatus, the first supporting apparatus is connected to the first displacement apparatus via a bending hinge. The first supporting apparatus is connected to the further first displacement apparatus via a bending hinge. The second supporting apparatus is connected to the second displacement apparatus via a bending hinge. The second supporting apparatus is connected to the further second displacement apparatus via a bending hinge.

In another embodiment of the apparatus, the further first movement stepping-down apparatus has a lever arm with a first end and a second end. The first end of the lever arm of the further first movement stepping-down apparatus is connected to the supporting plate. The second end of the lever arm of the further first movement stepping-down apparatus is moveable. The further second movement stepping-down apparatus has a lever arm with a first end and a second end. The first end of the lever arm of the further second movement stepping-down apparatus is connected to the supporting plate. The second end of the lever arm of the second movement stepping-down apparatus is moveable.

According to an embodiment of the apparatus, the first drive device can cause a movement change at the second end of the lever arm of the further first movement stepping-down apparatus. The second drive device can cause a movement change at the second end of the lever arm of the further second movement stepping-down apparatus.

A further embodiment provides for the lever arms to be in the form of part of the supporting plate and are composed of the same material as the supporting plate.

In one preferred embodiment, a respective area of the lever arms, which area is remote from their respective first end, is stamped out of the supporting plate.

According to a further preferred embodiment of the apparatus according to the invention, the lever arms are connected at their respective first ends to the supporting plate via a respective web.

In another embodiment of the apparatus, the first and the second drive device each have a lifting apparatus to deflect the respective second ends of the lever arms from a plane which is formed by the supporting plate, and have a respective motor to drive the respective lifting apparatus.

According to another embodiment, the respective lifting apparatuses of the first and second drive devices each have an eccentric which can rotate and is moved by a respective one of the motors of the first and second drive devices.

In a further embodiment of the apparatus, the third and the fourth drive device to displace the displacement apparatuses have a respective motor and an eccentric which can rotate. The respective motor of the third and the fourth drive device produces a rotary movement of the respective eccentric of the third and the fourth drive device. The rotary movement of the respective eccentric of the third and the fourth drive device produces a displacement of the displacement apparatuses in the longitudinal direction of the first and the second optical fiber.

According to one preferred embodiment, the displacement apparatuses each have a spring plate.

In one preferred embodiment, the supporting plate is in the form of a printed circuit board on which electrical lines are routed. By way of example, the printed circuit board may be in the form of a glass-fiber-reinforced printed circuit board. It is also possible for the supporting plate to be formed from a plastic or for it to be in the form of a metallic plate. In this case, a printed circuit board, on which electrical lines are routed, is preferably arranged under the supporting plate.

The use of a printed circuit board has the advantage that components such as electrode holders, illumination units to illuminate the optical fiber guides and the splicing area or else monitoring units, such as image processing units, can be arranged by an automatic placement device on the printed circuit board. Furthermore, supply lines to supply components such as these can likewise be integrated on the printed circuit board. There is therefore no need for complex wiring.

A further embodiment of an apparatus for positioning optical fibers, in which the optical fibers can be moved with respect to one another only in a longitudinal direction, comprises a supporting plate, a first optical fiber guide, into which at least a first optical fiber can be inserted, a second optical fiber guide, into which at least a second optical fiber can be inserted, a first displacement apparatus to displace the first optical fiber in a longitudinal direction of the first optical fiber, on which first displacement apparatus the first optical fiber guide is arranged, and a first drive device, which is coupled to the supporting plate and displaces the first optical fiber in the longitudinal direction of the first optical fiber by a force acting on the first displacement apparatus. The first displacement apparatus is configured such that it produces a restoring force opposing the force caused by the first drive device.

In an embodiment of the apparatus, a second displacement apparatus is provided for displacing the second optical fiber in a longitudinal direction of the second optical fiber, on which second displacement apparatus the second optical fiber guide is arranged. Furthermore, a second drive device is provided, which is coupled to the supporting plate and displaces the second optical fiber in the longitudinal direction of the second optical fiber by a force acting on the second displacement apparatus. The second displacement apparatus is configured such that it produces a restoring force opposing the force caused by the second drive device.

### BRIEF DESCRIPTION OF THE FIGURES

FIG. 1 shows an upper face of a supporting plate with an apparatus for splicing of optical fibers,

FIG. 2 shows a lower face of a supporting plate with an apparatus for splicing of optical fibers,

FIG. 3 shows a supporting plate for arranging an apparatus for splicing of optical fibers,

FIG. 4 shows displacement of optical fibers in a lateral direction, transversely with respect to a longitudinal direction of an optical fiber,

FIG. 5 shows arrangements of components in an area in a region surrounding a splice zone,

FIG. 6 shows two fiber bundles which must be aligned with respect to one another for a splicing process,

FIG. 7 shows a supporting plate for arranging an apparatus for splicing two fiber bundles,

FIG. 8 shows an upper face of a supporting plate with an apparatus for splicing two fiber bundles,

FIG. 9 shows a lower face of a supporting plate for arranging an apparatus for splicing two fiber bundles,

FIG. 10 shows a schematic illustration of displacement of two fiber bundles by means of an apparatus,

FIG. 11 shows spring plates to displace two fiber bundles to be spliced, in the longitudinal direction of the fiber bundles,

FIG. 12 shows a supporting plate connected to a printed circuit board.

### DETAILED DESCRIPTION OF THE INVENTION

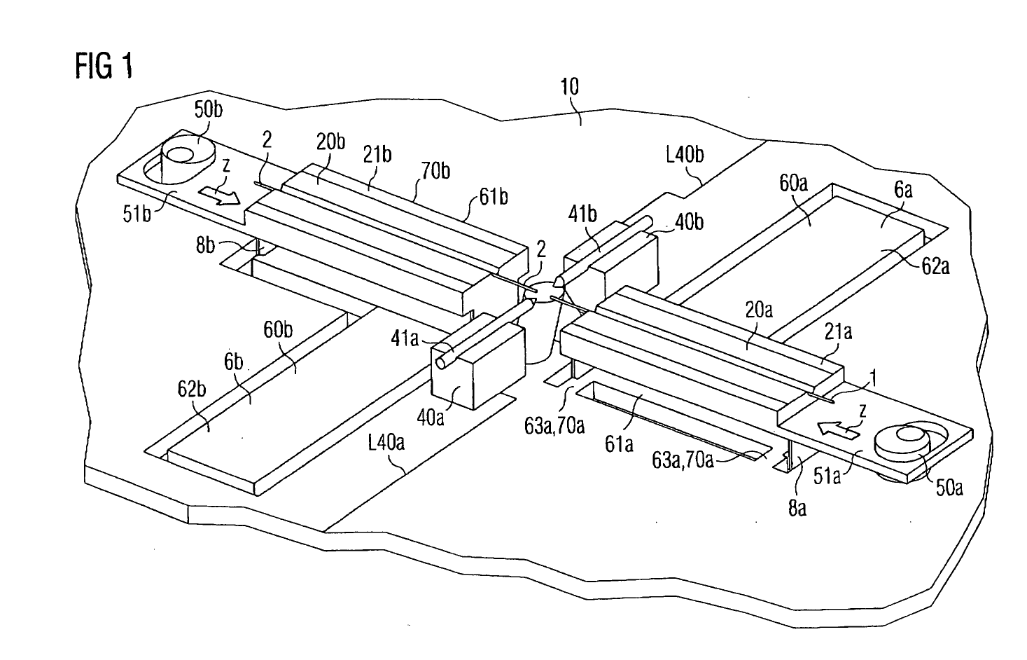

FIG. 1 shows an upper face of a supporting plate, on which various components of an apparatus for splicing two optical fibers are arranged. In order to splice an optical fiber 1 and an optical fiber 2, the ends of the two optical fibers are heated, are brought into contact, and are fused to one another. The heating of the two ends of the optical fibers required for the fusing process is produced by means of a corona discharge. For this purpose, an electrode holder 40a and an electrode holder 40b are arranged on the supporting plate. The arc which is created for the corona discharge is produced by an electrode 41a, which is arranged on the upper face of the electrode holder 40a, and an electrode 41b, which is arranged on the upper face of the electrode holder 40b.

The optical fibers 1 and 2 are each inserted in a groove in an optical fiber guide 20a and an optical fiber guide 20b. The optical fiber guides 20a and 20b are respectively arranged in a supporting apparatus 21a and a supporting apparatus 21b. The supporting apparatus 21a is mounted on a displacement apparatus 8a to displace the optical fiber 1 in a longitudinal direction Z of the optical fiber. The displacement apparatus 8a to displace the optical fiber 1 in the longitudinal direction Z of the optical fiber is, for example, in the form of a spring plate 80a. The spring plate 80a is bent by a lever 51a in the direction Z as shown in order to displace the optical fiber guide 20a, to be precise the optical fiber 1, in its longitudinal direction in the direction of the end of the optical fiber 2. The spring plate 80a is bent by means of a drive device A3. There is a cutout, in which an eccentric 50a engages, at one end of the lever 51a. The lever 51a is displaced in the Z direction by a rotary movement of the eccentric, and forces the spring plate 80a with the optical fiber guide 20a in the direction of the optical fiber 2.

The optical fiber guide 20b of the optical fiber 2 is likewise arranged in a supporting apparatus 21b. The supporting apparatus 21b is mounted on a displacement apparatus 8b to displace the optical fiber 2 in its longitudinal direction Z in the direction of the optical fiber 1. The displacement apparatus 8b to displace the optical fiber 2 in its longitudinal direction is preferably in the form of a spring plate 80b. The spring plate 80b can be bent by the action of a force by means of a drive device A4 via a lever 51b such that the optical fiber guide 20b, to be precise the optical fiber 2, is moved in the direction of the optical fiber 1. The lever 51b is displaced by rotation of an eccentric 50b, which engages in a cutout at the end of the lever 51b. The optical fibers can thus be displaced in the negative Z direction by bending the two spring plates 80a and 80b, such that their ends can be brought into contact with one another, for a splicing process.

In order to allow the two ends of the optical fibers 1 and 2 to be aligned precisely with respect to one another, it must also be possible to displace the optical fibers in a lateral direction, transversely with respect to their respective longitudinal direction. In order to displace the optical fiber 1, the spring plate 80a and therefore the optical fiber guide 20a are arranged on a movement stepping-down apparatus 6a to displace the optical fiber 1 in its lateral direction. The movement stepping-down apparatus 6a comprises a lever arm 60a which can be bent about a bending axis 70a. The lever arm 60a is stamped out of the printed circuit board 10 as part of the printed circuit board, and is connected to the rest of the printed circuit board at only one end 61a, via two narrow webs 63a. When a force is applied to the end 62a, the lever arm 60a can be bent about the bending axis 70a, thus also resulting in the optical fiber 1 being displaced in a lateral direction in the optical fiber guide 20a.

In order to displace the optical fiber 2 in a lateral direction, transversely with respect to its longitudinal direction, the spring plate 80b is likewise arranged on a movement stepping-down apparatus 6b to displace the optical fiber 2 in a lateral direction. The movement stepping-down apparatus 6b comprises a lever arm 60b which is connected to the rest of the printed circuit board 10 at only one end 61b, via narrow webs, in a similar manner to the lever arm 60a. Otherwise, the lever arm 60b is stamped out of the printed circuit board. The optical fiber 2 can be displaced in the lateral direction in the optical fiber guide 20b by bending a free end 62b.

According to the invention, the optical fiber, to be precise the optical fiber guides 20a and 20b, are therefore displaced in the longitudinal direction of the respective optical fibers by bending two spring plates 80a and 80b. The two optical fibers are displaced in the lateral direction by bending two lever arms 60a and 60b. The spring plates 80a and 80b as well as the lever arms 60a and 60b therefore replace the previously normal precision guides, for example linear guides with ball bearings. The spring plates as well as the two lever arms allow the adjustment forces acting on them to be stepped down. By way of example, a conventional stepping motor may be used to move the two eccentrics 50a and 50b. A large force applied to the spring plates is stepped down by the restoring force of the spring plates to a small displacement of the optical fibers in their longitudinal direction.

In the same way, the lever arms 60a and 60b for displacing the optical fibers in the lateral direction also result in the forces acting at their ends 62a and 62b being stepped down. A large movement resulting from a large force applied to the ends 62a and 62b of the lever arms can produce a much smaller displacement of the optical fiber guides 20a and 20b which are arranged in the vicinity of the bending axes 70a and 70b at the ends 61a and 61b of the lever arms. The optical fibers can therefore be displaced slightly in their lateral direction by a large force applied to the ends 62a and 62b of the lever arms. The step-down ratio is in this case dependent on the length of the lever arms, and can be chosen within wide ranges.

Movement actuators, such as low-cost stepping motors, or else thermal expansion elements or solenoid actuators, can be arranged at the ends 60a and 60b. These cause the lever arms 60a and 60b to be bent about their bending axes 70a and 70b. Non-linear movement changes on the movement actuators, which are caused, for example, by the surface roughness of the eccentrics of the adjustment motors, are in this case also advantageously stepped down by the step-down ratio of the lever arms. This stepping down is further enhanced by the bending of the lever arms, and by the geometric discrepancy from a straight lever arm resulting from this.

According to the invention, the necessary precision positioning of the optical fibers for the splicing process is therefore achieved by a low-cost, relatively coarse movement mechanism, by bending and by appropriate stepping down. This makes it possible to replace costly elements such as precision guides, precision mechanical parts as well as expensive piezo-components by simpler mechanical parts and drive components. The required precision for alignment of the optical fibers is produced again by stepping down by means of a bending apparatus.

The supporting plate 10 is preferably in the form of a printed circuit board. This makes it possible to solder numerous components onto the printed circuit board, such as the electrode holders with their corona-discharge electrical system. Conductor tracks L40a and L40b on the printed circuit board avoids the previously necessary wiring complexity for the electrode holders. The use of a printed circuit board likewise makes it possible to place numerous components, such as the electrode holders, precisely on the printed circuit board by automatic component placement on the printed circuit board with the aid of the normal automatic placement devices for printed circuit board construction.

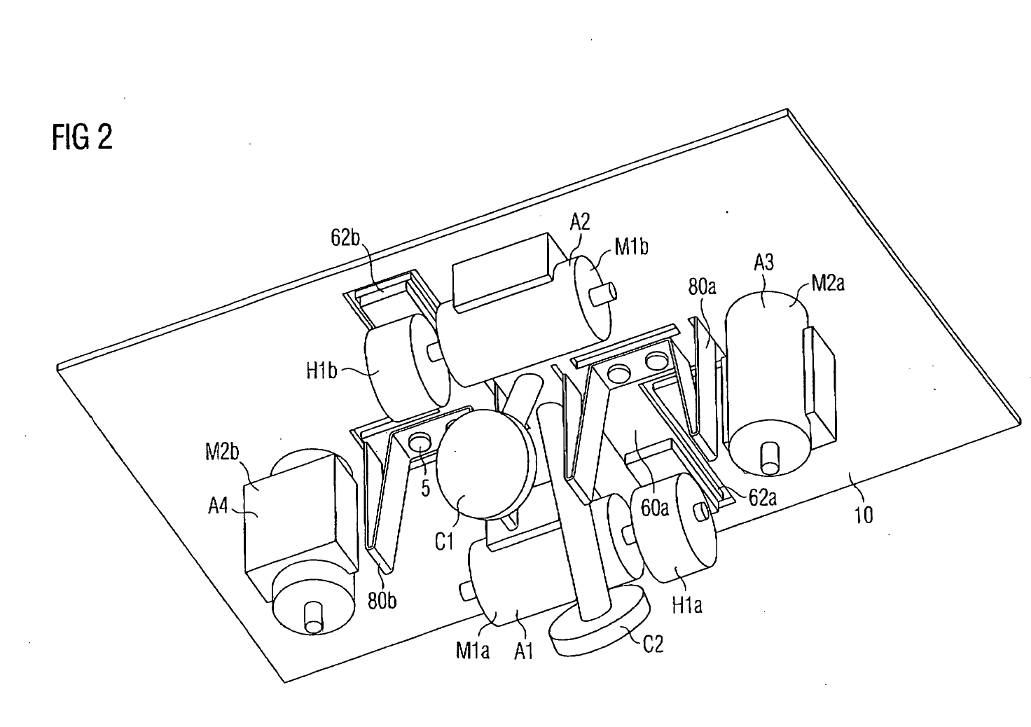

FIG. 2 shows a lower face of the supporting plate 10. Drive devices A1, A2, A3 and A4 are arranged under the supporting plate. The drive devices each have a motor, which is connected to a lifting apparatus via a rod. A lifting apparatus H1a, which is driven by a motor M1a, is arranged under the loose end 62a of the lever arm 60a. By way of example, the lifting apparatus H1a may be in the form of an eccentric. A lifting apparatus H1b, which is driven by a motor M1b, is arranged under a loose end 62b of the lever arm 60b. In this case as well, the lifting apparatus H1b is preferably in the form of an eccentric. The motors are each connected via holders to the lower face of the supporting plate 10.

The spring plates 80a and 80b are connected to the lever arms 60a and 60b via attachment elements S 5, for example screws or rivets. A motor M2a is fitted in a holder under the eccentric 50a. A further motor M2b is fitted under the eccentric 50b. The motors allow the eccentrics 50a and 50b to be rotated in order to bend the spring plates 80a and 80b in the Z direction.

By way of example, low-cost stepping motors may be used as the motors. In addition to the motors and lifting apparatuses illustrated in FIG. 2 by means of eccentrics, it is also possible to use other movement actuators, for example thermal expansion elements or solenoid actuators. If a printed circuit board is used as the supporting plate, the movement actuators can advantageously be fitted under the printed circuit board by automatic placement by means of an automatic placement device. Since the supply lines for supplying voltage to the movement actuators can be integrated in or on the printed circuit board, this avoids complex wiring for the movement actuators.

Furthermore, image processing devices C1 and C2, for example CCD cameras, are arranged on the lower face. The beam path of these optics is in the form of a cylinder and ends, as can be seen in FIG. 1, directly under the ends of the optical fibers to be spliced.

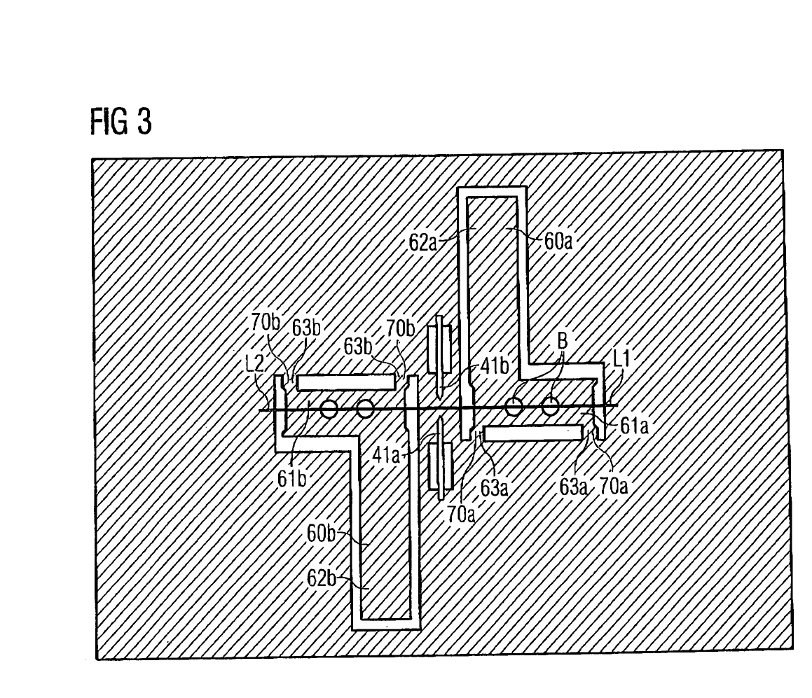

FIG. 3 shows the supporting plate 10, without the optical fiber guides 20a and 20b and without the displacement apparatuses 8a and 8b for displacing the optical fibers in the longitudinal direction. The bendable lever arm 60a is stamped out of the supporting plate 10, and is connected to the rest of the supporting plate via webs 63a. The lever arm 60b is stamped out of the printed circuit board 10, and is connected to the supporting plate just via the webs 63b. The webs 63a and 63b allow the respective lever arms to be bent about the bending axes 70a and 70b. As can also be seen from FIG. 2, the spring plates may be connected to the lever arms by means, for example, of a screwed joint or riveted joint. Holes B are provided in each of the lever arms for this purpose.

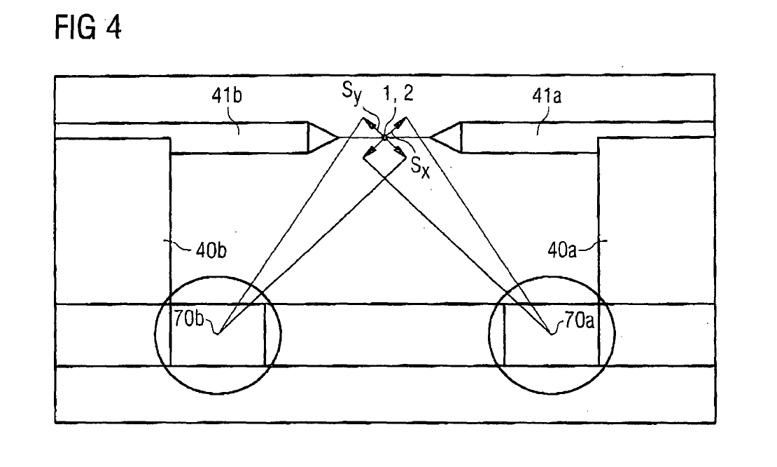

FIG. 4 shows the electrode holder 40a with the electrode 41a arranged on it, as well as the electrode holder 40b with the electrode 41b arranged on it. The optical fiber 1 can be displaced along the lateral direction Sx by bending the lever arm 60a about the bending axis 70a. The optical fiber 2 can be displaced along the lateral direction Sy by bending the lever arm 60b. When bending occurs, this therefore results in two approximately mutually perpendicular movement vectors Sx and Sy.

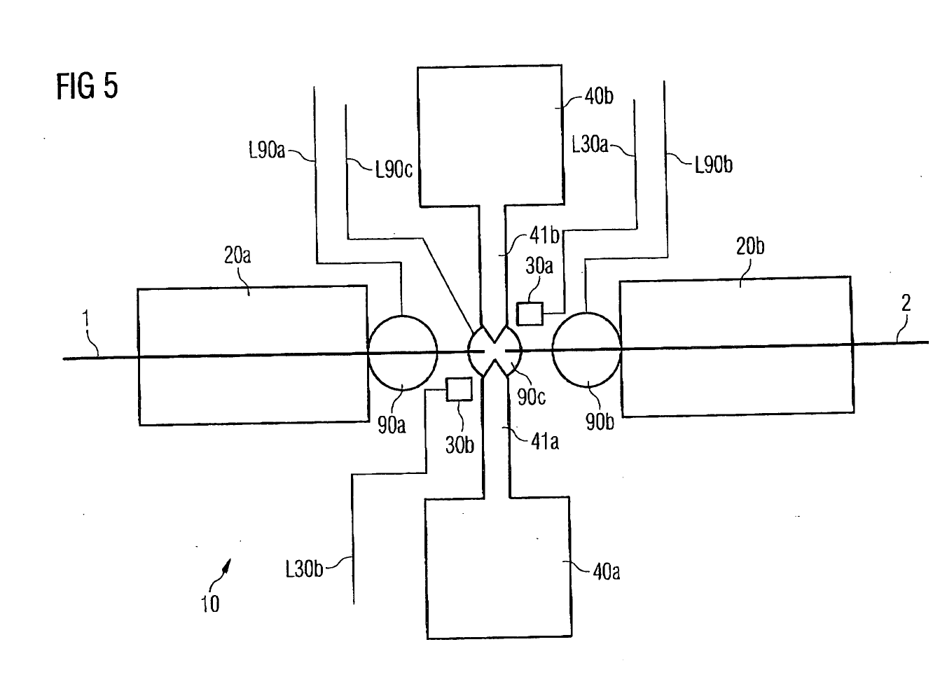

FIG. 5 shows components on the supporting plate 10 in the immediate vicinity of a splice point between the optical waveguides 1 and 2 to be spliced. The optical fiber 1 is arranged in the optical fiber guide 20a. The optical fiber 2 is arranged in the optical fiber guide 20b. Once they have been aligned with respect to one another, the ends of the two optical waveguides are heated by the two electrodes 41a and 41b, which are arranged on the electrode holders 40a and 40b.

An illumination device 90a to illuminate an insertion area for the optical fiber guide 20a is located on the supporting plate 10 in the area of the electrode holder 20a. An illumination device 90b to illuminate an insertion area for the optical fiber guide 20b is located adjacent to the electrode holder 20b. The insertion areas are, for example, in the form of grooves. A further illumination device 90c to illuminate the splice zone is located under the two ends of the optical fibers to be spliced. By way of example, LEDs may be used as illumination devices for illuminating the insertion areas and the actual splice zone.

If the supporting plate 10 is in the form of a printed circuit board, there is no need for complex wiring for the illumination devices either. Voltage supplies L90a for the illumination device 90a, L90b for the illumination device 90b, and L90c for the illumination device 90c may in this case preferably be integrated directly on the printed circuit board.

A camera chip 30a and a camera chip 30b are preferably arranged on the supporting plate 10 for video monitoring of a splicing process. When a printed circuit board is used as the supporting plate, the voltage supply lines L30a and L30b providing the supply can also in this case be arranged on the printed circuit board.

When a printed circuit board is used as the supporting plate, the illumination devices 90a, 90b, 90c and the camera chips 30a and 30b can also in this case be arranged by automatic placement by means of an automatic placement device. It is likewise possible, instead of using different illumination devices on the printed circuit board 10, to provide one illumination device, for example an LED, whose light beam is passed via various deflection mirrors to the insertion areas of the optical fiber guides, and to the splice zone.

The following text describes a modified arrangement of the apparatus for splicing optical fibers, which is particularly suitable for aligning a plurality of optical fibers, a so-called fiber ribbon, for a splicing process.

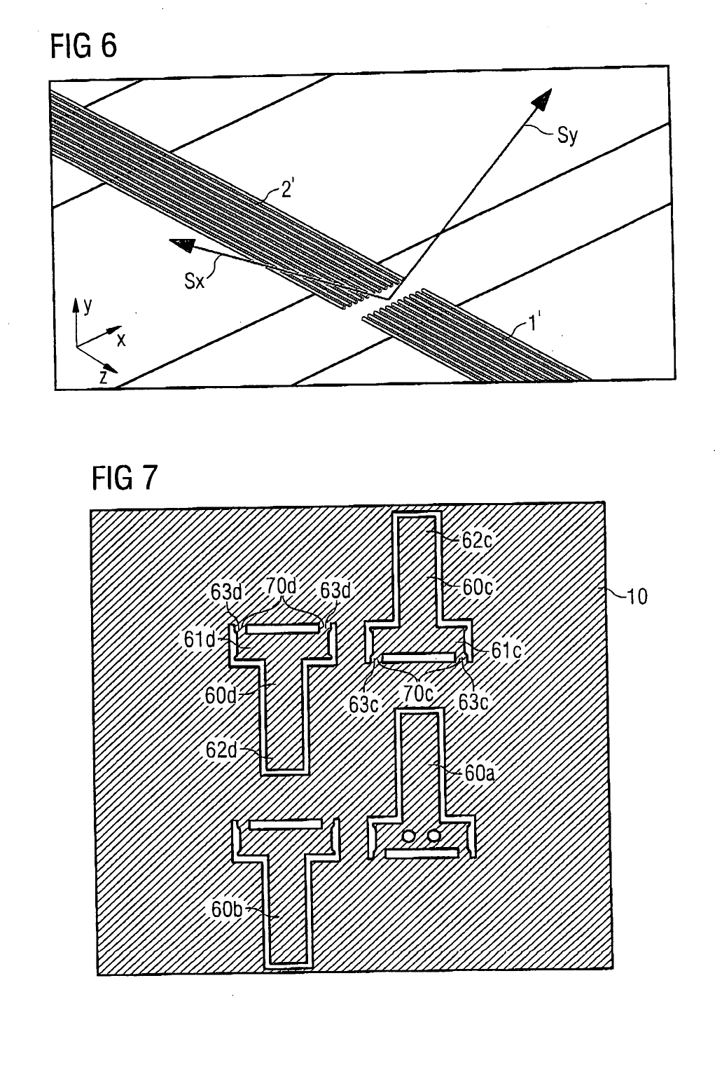

In this context, FIG. 6 shows a fiber ribbon 1′ and a fiber ribbon 2′. The individual fiber ribbon comprise a plurality of optical fibers arranged alongside one another. The apparatuses for displacing the fiber ribbons in a lateral direction Sx and a lateral direction Sy should in this case preferably be designed so as to avoid rotation of the ribbons around their center axis since, otherwise, this would result in different offsets between the individual optical fibers to be spliced.

In this context, FIG. 7 shows the supporting plate 10 which, in addition to the two lever arms 60a and 60b, now additionally has the lever arms 60c and 60d. The lever arms 60c and 60d are identical to the lever arms 60a and 60b. They are each stamped out of the printed circuit board 10, and are connected to the rest of the supporting plate 10 via respective narrow webs 63c and 63d. When a force is applied to a loose end 62c of the lever arm 60c, this lever arm is bent about a bending axis 70c. When a force is applied to a loose end 62d of the lever arm 60d, this lever arm is bent about the bending axis 70d.

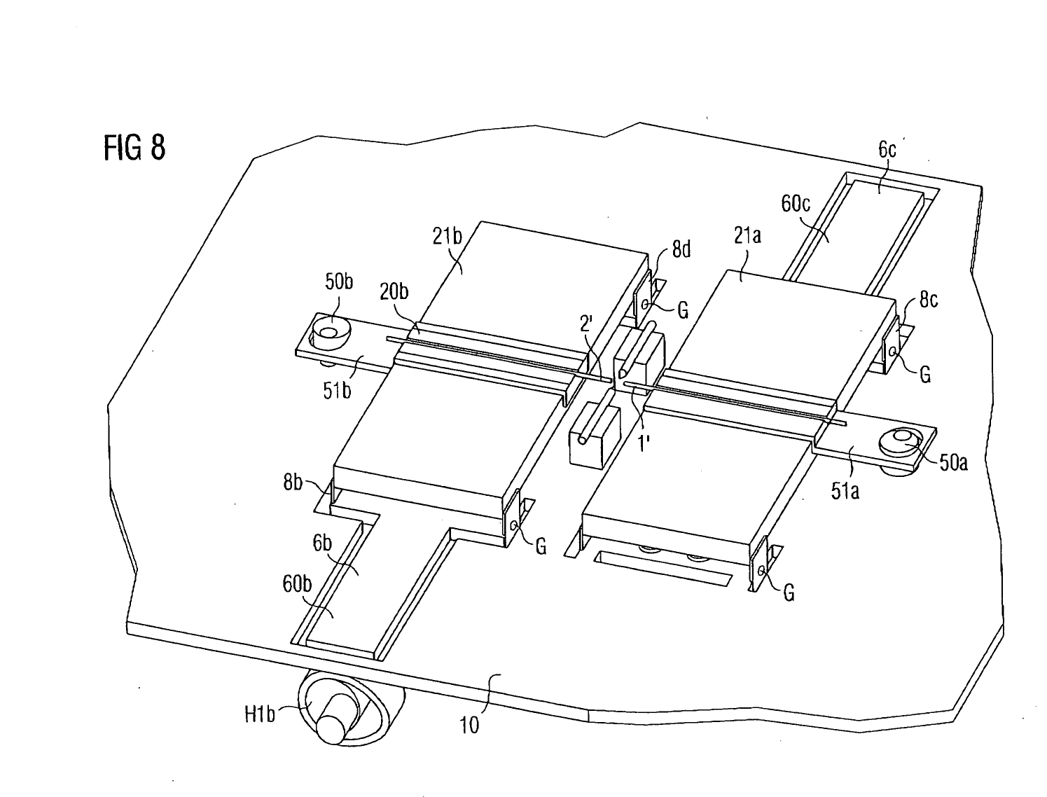

FIG. 8 shows an upper face of the supporting plate 10, on which further components are arranged for aligning the fiber ribbons 1′ and 2′ and the electrode holders for splicing the fiber ribbons. The optical fiber guide 20a is arranged on a supporting apparatus 21a. The supporting apparatus 21a is connected via a joint G both to the spring plate 80a and to a spring plate 80c. The supporting apparatus can be displaced in a lateral direction transversely with respect to the longitudinal direction of the fiber ribbon 1′ by uniform bending of the loose ends 62a and 62c of the lever arms 60a and 60c. Since the spring plate 80a and the spring plate 80c are connected via a joint to the supporting apparatus 21a, this ensures that the individual fibers of the fiber ribbon 1′ cannot be twisted while the lever arms 60a and 60c are being bent.

The optical fiber guide 20b is likewise arranged on a supporting apparatus 21b, which is connected via a joint G to the spring plate 80b which is arranged on the lever arm 60b, and is connected to a spring plate 80d which is arranged on the lever arm 60d. The supporting apparatus 21b and therefore the entire fiber ribbon 2′ as well can be displaced in a lateral direction Sy transversely with respect to the longitudinal direction of the fiber ribbon 2′ by simultaneous bending of the loose ends 62b of the lever arm 60b and the loose end 62d of the lever arm 60d. Since the spring plates 80b and 80d are connected to the supporting apparatus 21b via joints G, this also ensures in this case that the individual optical fibers in the fiber ribbon 2′ are not twisted.

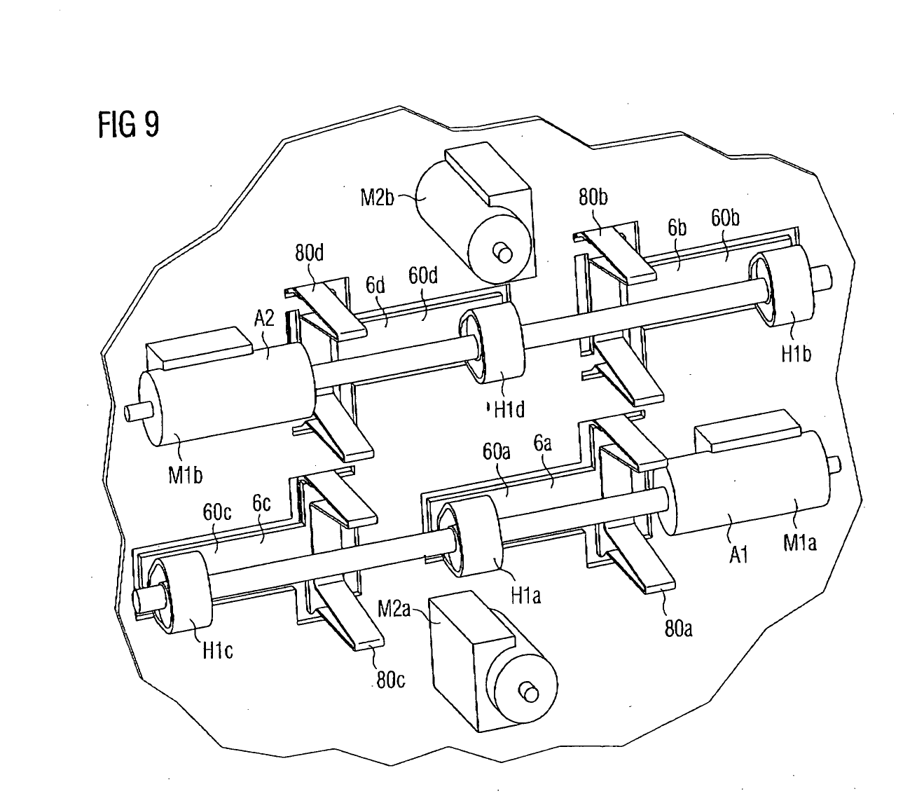

FIG. 9 shows a lower face of the supporting plate 10. The rotary movement of the eccentric 50a in order to bend the spring plates 80a and 80c in the longitudinal direction of the fiber ribbon 1′ is produced by the motor M2a. The motor M2a is connected to the eccentric 50a, which displaces the spring plates 80a and 80c in the longitudinal direction of the fiber ribbon 1′, via a lever 51a. Rotation of the eccentric 50b likewise results in displacement of the spring plates 80b and 80d in the longitudinal direction of the fiber ribbon 2′. The eccentric 50b is driven by the motor M2b, which is arranged under the supporting plate.

The lever arms 60a and 60c are bent via a lifting apparatus H1a and a lifting apparatus H1c. The lifting apparatuses H1a and H1c are preferably in the form of eccentrics, which are connected to the motor M1a via a common connecting shaft. The lever arms 60b and 60d are bent by a rotary movement of two lifting apparatuses H1b and H1d in the form of eccentrics. The eccentrics H1b and H1d are connected to the motor M1b via a common connecting shaft. When deliberate rotation is required for fine positioning of the ribbon lateral axes with respect to one another, then two motors may be used instead of one motor for simultaneous bending of the lever arms 60a and 60c, and of the lever arms 60b and 60d. In this case, by way of example, the lifting apparatus H1c is not connected to the motor M1a via the common shaft. The lifting apparatus H1c is in this case driven by its own motor. The lifting apparatus H1b is likewise not driven by the motor M1b via the common shaft. In this case, this is also driven by its own motor.

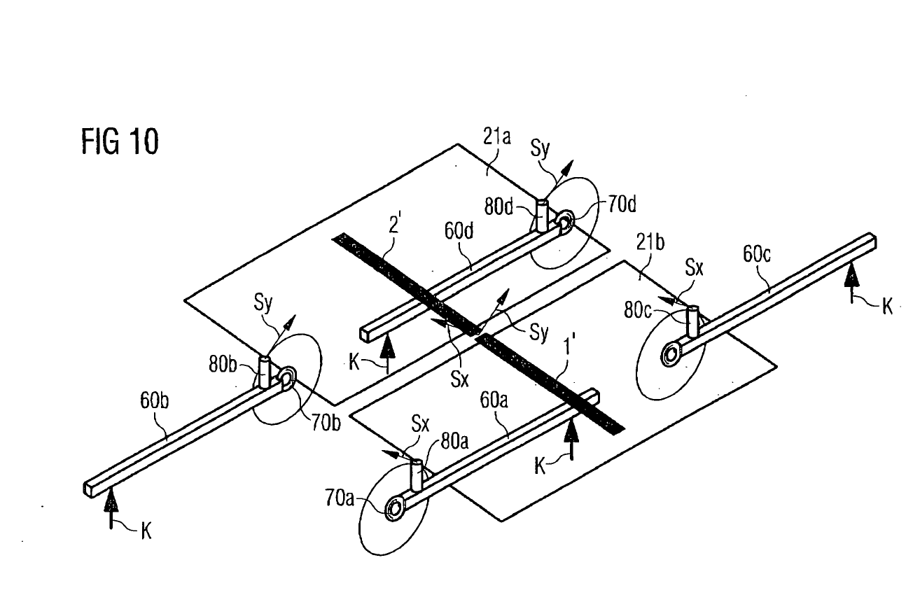

FIG. 10 clearly shows the principle of the positioning mechanism for displacing the fiber ribbons 1′ and 2′ in the lateral direction Sx and the lateral direction Sy. At their loose ends, the lever arms 60a and 60c are bent by a force component K about their bending axes 70a and 70c. In the area of their bending axes 70a and 70c, the lever arms 60a and 60c are connected via a raised area which, for example, is formed by a limb of the spring plates 80a and 80c, to the supporting apparatus 21a for the optical fiber guide 20a. When a force is applied to the loose ends of the lever arms 60a and 60c, the supporting apparatus 21a is displaced in the lateral direction Sx.

The lever arms 60b and 60d are used for displacing the supporting apparatus 21b for the optical fiber guide 20b in the lateral direction Sy of the fiber ribbon 2′. For this purpose, the supporting apparatus 21b is connected to the lever arms 60b and 60d via raised areas which are formed by the limbs of the spring plates 80b and 80d. When a force K is applied to the free end of the lever arms 60b and 60d, the supporting apparatus 21b is displaced in the lateral direction Sy.

A bending hinge, for example the joint G illustrated in FIG. 8, is located at the area at which the limbs of the spring plates are connected to the supporting apparatus 21a and to the supporting apparatus 21b. The bending hinge prevents stress occurring at the junction area between the spring plate and the supporting apparatus during bending of the lever arms.

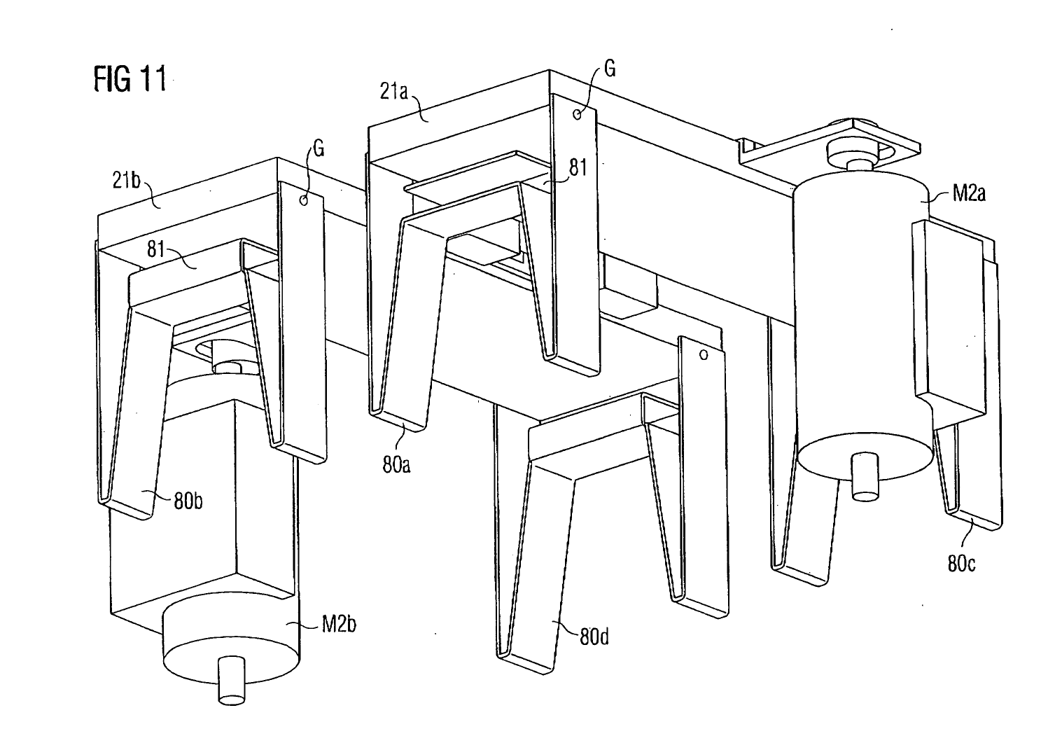

FIG. 11 shows the spring plates 80a and 80c for displacing the fiber ribbon 1′ in the longitudinal direction, as well as the spring plates 80b and 80d for displacing the fiber ribbon 2′ in the longitudinal direction. The lever arms engage in respective lugs 81 on the spring plates. The spring plates 80a and 80c are each connected to the supporting apparatus 21a via a joint G. The spring plates 80b and 80d are likewise each connected to the supporting apparatus 21b via a joint G. Stresses between the supporting apparatuses and the limbs of the spring plates connected to them during bending of the lever arms are prevented by there being no rigid connection between the spring plate and the supporting apparatus.

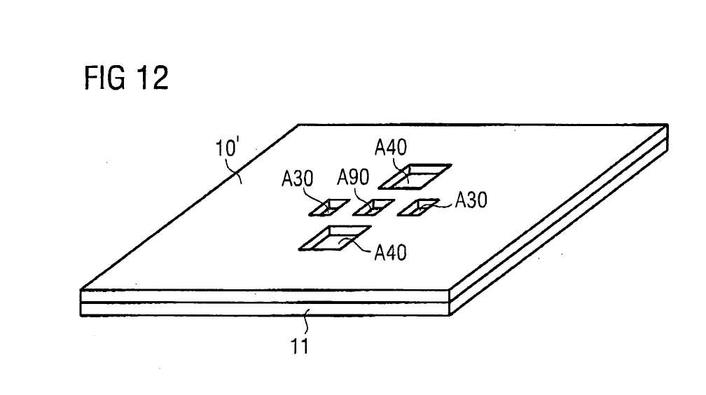

FIG. 12 shows a two-layer embodiment of the supporting plate. By way of example, the supporting plate 10′ is formed from a plastic material or a metal. A printed circuit board 11 is arranged under the plastic or metal plate. If the supporting plate 10′ is in the form of a metallic plate, for example composed of a flexible sheet-metal material, the lever arms are arranged, for example as flexible sheet-metal parts, on the supporting plate 10′. Cutouts A40, A30 and A90 are provided in the area of the electrode holders 40 and in the area of the camera chips 30 and of the illumination devices 90 on the metallic supporting plate 10′ and/or the plastic supporting plate 10′. The electrode holders 40, the camera chips 30 and the illumination devices 90 can be soldered directly on the printed circuit board 11 through the cutouts. They may be connected to a voltage supply by means of supply lines which are integrated in the printed circuit board 11.

We claim:

1. An apparatus for positioning optical fibers, comprising:
a supporting plate,
a first optical fiber guide, into which at least a first optical fiber can be inserted,
a second optical fiber guide, into which at least a second optical fiber can be inserted,
a first movement stepping-down apparatus to displace the first optical fiber in a lateral direction transversely with respect to a longitudinal direction of the first optical fiber, which first movement stepping-down apparatus has a first end and a second end,
wherein the first optical fiber guide is arranged on an area of the first movement stepping-down apparatus which is closely adjacent to the first end of the first movement stepping-down apparatus,
a first drive device, which is coupled to the supporting plate and which can cause a change in the position at the second end of the first movement stepping-down apparatus,
wherein the first movement stepping-down apparatus is configured to convert the movement change caused by the first drive device at the second end of the first movement stepping-down apparatus to a smaller movement change on the area of the first movement stepping-down apparatus which is closely adjacent to the first end of the first movement stepping-down apparatus.

2. The apparatus of claim 1, comprising:
a second movement stepping-down apparatus to displace the second optical fiber in a lateral direction transversely with respect to a longitudinal direction of the second optical fiber, which second movement stepping-down apparatus has a first end and a second end,
wherein the second optical fiber guide is arranged on an area of the second movement stepping-down apparatus which is closely adjacent to the first end of the second movement stepping-down apparatus,
a second drive device, which is coupled to the supporting plate and which can cause a change in the position at the second end of the second movement stepping-down apparatus,
wherein the second movement stepping-down apparatus is configured to convert the movement change caused by the second drive device at the second end of the second movement stepping-down apparatus to a smaller movement change on the area of the second movement stepping-down apparatus which is closely adjacent to the first end of the second movement stepping-down apparatus.

3. The apparatus of claim 1, comprising:
a first displacement apparatus to displace the first optical fiber in the longitudinal direction of the first optical fiber, on which first displacement apparatus the first optical fiber guide is arranged,
a third drive device, which is coupled to the supporting plate and causes displacement of the first optical fiber in the longitudinal direction of the first optical fiber by means of a force acting on the first displacement apparatus,
wherein the first displacement apparatus is configured such that it produces a restoring force opposing the force caused by the third drive device,
wherein the first displacement apparatus is coupled to that area of the first movement stepping-down apparatus which is closely adjacent to the first end of the first movement stepping-down apparatus.

4. The apparatus of claim 3, comprising:
a second displacement apparatus to displace the second optical fiber in the longitudinal direction of the second optical fiber, on which second displacement apparatus the second optical fiber guide is arranged,
a fourth drive device, which is coupled to the supporting plate and causes displacement of the second optical fiber in the longitudinal direction of the second optical fiber by means of a force acting on the second displacement apparatus,
wherein the second displacement apparatus is configured such that it produces a restoring force opposing the force caused by the fourth drive device,
wherein the second displacement apparatus is coupled to that area of the second movement stepping-down apparatus which is closely adjacent to the first end of the second movement stepping-down apparatus.

5. The apparatus of claim 4, comprising:
a first supporting apparatus on which the first optical fiber guide is arranged,
wherein the first supporting apparatus is coupled to the first displacement apparatus,
a second supporting apparatus on which the second optical fiber guide is arranged,
wherein the second supporting apparatus is coupled to the second displacement apparatus.

6. The apparatus of claim 2,
wherein the first movement stepping-down apparatus has a lever arm with a first end and a second end,
wherein the first end of the lever arm of the first movement stepping-down apparatus is connected to the supporting plate,
wherein the second end of the lever arm of the first movement stepping-down apparatus can be moved by the first drive device,
wherein the second movement stepping-down apparatus has a lever arm with a first end and a second end,
wherein the first end of the lever arm of the second movement stepping-down apparatus is connected to the supporting plate,
wherein the second end of the lever arm of the second movement stepping-down apparatus can be moved by the second drive device.

7. The apparatus of claim 3, comprising:
a further first movement stepping-down apparatus to displace the first optical fiber in the lateral direction for the first optical fiber, which further first movement stepping-down apparatus has a first end and a second end,
wherein the further first movement stepping-down apparatus is configured to convert a movement change caused at the second end of the further first movement stepping-down apparatus to a smaller movement change on the area of the further first movement stepping-down apparatus which is closely adjacent to the first end of the further first movement stepping-down apparatus,
a further first displacement apparatus to displace the first optical fiber in the longitudinal direction of the first optical fiber as a consequence of a force caused by the third drive device,
wherein the further first displacement apparatus is configured such that it produces a restoring force opposing the force caused by the third drive device,
wherein the further first displacement apparatus is coupled to that area of the further first movement stepping-down apparatus which is closely adjacent to the first end of the further first movement stepping-down apparatus,
wherein the first supporting apparatus is arranged on the further first displacement apparatus.

8. The apparatus of claim 7, comprising:
a further second movement stepping-down apparatus to displace the second optical fiber in the lateral direction for the second optical fiber, which further second movement stepping-down apparatus has a first end and a second end,
wherein the further second movement stepping-down apparatus is configured to convert a movement change caused at the second end of the further second movement stepping-down apparatus to a smaller movement change on the area of the further second movement stepping-down apparatus which is closely adjacent to the first end of the further second movement stepping-down apparatus,
a further second displacement apparatus to displace the second optical fiber in the longitudinal direction of the second optical fiber as a consequence of a force caused by the fourth drive device,
wherein the further second displacement apparatus is configured such that it produces a restoring force opposing the force caused by the fourth drive device,
wherein the further second displacement apparatus is coupled to that area of the further second movement stepping-down apparatus which is closely adjacent to the first end of the further second movement stepping-down apparatus,
wherein the supporting apparatus on which the second optical fiber guide is arranged is arranged on the further second displacement apparatus.

9. The apparatus of claim 8,
wherein the first supporting apparatus is connected to the first displacement apparatus via a bending hinge,
wherein the first supporting apparatus is connected to the further first displacement apparatus via a bending hinge,
wherein the second supporting apparatus is connected to the second displacement apparatus via a bending hinge,
wherein the second supporting apparatus is connected to the further second displacement apparatus via a bending hinge.

10. The apparatus of claim 8,
wherein the further first movement stepping-down apparatus has a lever arm with a first end and a second end,
wherein the first end of the lever arm of the further first movement stepping-down apparatus is connected to the supporting plate,
wherein the second end of the lever arm of the further first movement stepping-down apparatus is moveable,
wherein the further second movement stepping-down apparatus has a lever arm with a first end and a second end,
wherein the first end of the lever arm of the further second movement stepping-down apparatus is connected to the supporting plate,
wherein the second end of the lever arm of the second movement stepping-down apparatus is moveable.

11. The apparatus of claim 10,
wherein the first drive device can cause a movement change at the second end of the lever arm of the further first movement stepping-down apparatus,
wherein the second drive device can cause a movement change at the second end of the lever arm of the further second movement stepping-down apparatus.

12. The apparatus of claim 10,
wherein the lever arms are in the form of part of the supporting plate and are composed of the same material as the supporting plate.

13. The apparatus of claim 12,
wherein a respective area of the lever arms, which area is remote from their respective first end, is stamped out of the supporting plate.

14. The apparatus of claim 12,
wherein the lever arms are connected at their respective first ends to the supporting plate via a respective web.

15. The apparatus of claim 1,
wherein the first and the second drive device each have a lifting apparatus to deflect the respective second ends of the lever arms from a plane which is formed by the supporting plate, and have a respective motor for driving the respective lifting apparatus.

16. The apparatus of claim 15,
wherein the respective lifting apparatuses of the first and the second drive device are arranged in an area under the respective second ends of the lever arms.

17. The apparatus of claim 16,
wherein the respective lifting apparatuses of the first and second drive devices each have an eccentric which can rotate and is moved by a respective one of the motors of the first and second drive devices.

18. The apparatus of claim 4,
wherein the third and the fourth drive device to displace the displacement apparatuses have a respective motor and an eccentric which can rotate,
wherein the respective motor of the third and the fourth drive device produces a rotary movement of the respective eccentric of the third and the fourth drive device,
wherein the rotary movement of the respective eccentric of the third and the fourth drive device produces a displacement of the displacement apparatuses in the longitudinal direction of the first and the second optical fiber.

19. The apparatus of claim 4,
wherein the displacement apparatuses each have a spring plate.

20. The apparatus of claim 18,
wherein the motors of the drive devices are each arranged under the supporting plate.

21. The apparatus of claim 18,
wherein the motors of the drive devices are each in the form of a stepping motor.

22. The apparatus of claim 1,
wherein the supporting plate is in the form of a printed circuit board on which electrical lines are routed.

23. The apparatus of claim 22,
wherein the printed circuit board is in the form of a glass-fiber-reinforced printed circuit board.

24. The apparatus of claim 1,
wherein the supporting plate is formed from a plastic.

25. The apparatus of claim 21,
wherein the supporting plate is in the form of a metallic plate.

26. The apparatus of claim 24,
wherein a printed circuit board, on which electrical lines are routed, is arranged under the supporting plate.

27. The apparatus of claim 22, comprising:
a first electrode holder and a second electrode holder to produce a corona discharge for splicing the first and the second optical fiber,
wherein the electrode holders are arranged on the printed circuit board,
wherein supply lines to supply voltage to the electrode holders are arranged on the printed circuit board.

28. The apparatus of claim 22, comprising:
a first illumination unit to illuminate the first optical fiber guide,
a second illumination unit to illuminate the second optical fiber guide,
wherein the first and the second illumination unit are arranged on the printed circuit board,
wherein supply lines to supply voltage to the first and the second illumination unit are arranged on the printed circuit board.

29. The apparatus of claim 22, comprising:
a third illumination unit to illuminate a splice zone of the first and the second optical fiber,
wherein the third illumination unit is arranged on the printed circuit board,
wherein supply lines to supply voltage to the third illumination unit are arranged on the printed circuit board.

30. The apparatus of claim 22, comprising:
an image processing unit, which is arranged on the printed circuit board,
wherein supply lines to supply voltage to the image processing unit are arranged on the printed circuit board.

31. An apparatus for positioning optical fibers, comprising:
a supporting plate,
a first optical fiber guide, into which at least a first optical fiber can be inserted,
a second optical fiber guide, into which at least a second optical fiber can be inserted,
a first displacement apparatus to displace the first optical fiber in a longitudinal direction of the first optical fiber, on which first displacement apparatus the first optical fiber guide is arranged,
a first drive device, which is coupled to the supporting plate and displaces the first optical fiber in the longitudinal direction of the first optical fiber by a force acting on the first displacement apparatus,
wherein the first displacement apparatus is configured such that it produces a restoring force opposing the force caused by the first drive device.

32. The apparatus of claim 31, comprising:
a second displacement apparatus to displace the second optical fiber in a longitudinal direction of the second optical fiber, on which second displacement apparatus the second optical fiber guide is arranged,
a second drive device, which is coupled to the supporting plate and displaces the second optical fiber in the longitudinal direction of the second optical fiber by a force acting on the second displacement apparatus,
wherein the second displacement apparatus is configured such that it produces a restoring force opposing the force caused by the second drive device.

33. The apparatus of claim 31,
wherein the displacement apparatuses have a respective spring plate.

34. The apparatus of claim 31,
wherein the first and the second drive device have a respective motor and an eccentric which can rotate in order to displace the displacement apparatuses,
wherein the respective motor of the first and the second drive device produces a rotary movement of the respective eccentric of the first and the second drive device,
wherein the rotary movement of the respective eccentric of the first and the second drive device displaces the displacement apparatuses in the longitudinal direction of the first and the second optical fiber.

35. The apparatus of claim 34,
wherein the motors of the drive devices are each arranged under the supporting plate.

36. The apparatus of claim 34,
wherein the motors of the drive devices are each in the form of a stepping motor.

37. The apparatus of claim 31,
wherein the supporting plate is in the form of a printed circuit board, on which electrical lines are routed.

38. The apparatus of claim 37,
wherein the printed circuit board is in the form of a glass-fiber-reinforced printed circuit board.

39. The apparatus of claim 31,
wherein the supporting plate is formed from a plastic.

40. The apparatus of claim 31,
wherein the supporting plate is in the form of a metallic plate.

41. The apparatus of claim 39,
wherein a printed circuit board on which electrical lines are routed is arranged under the supporting plate.
